(19) United States
(12) Patent Application Publication
(10) Pub. No.: US 2026/0144699 A1
(43) Pub. Date: May 28, 2026

(54) MASSAGER STRUCTURE

(71) Applicant: Xiaolin Tang, Dongguan (CN)

(72) Inventor: Xiaolin Tang, Dongguan (CN)

(21) Appl. No.: 19/069,282

(22) Filed: Mar. 4, 2025

(30) Foreign Application Priority Data
Nov. 26, 2024 (CN) 202422888277.4

(51) Int. Cl. A61H 7/00

(52) U.S. Cl. CPC A61H 7/007; A61H 2201/1215; A61H 2201/1472; A61H 2201/1671

(57) ABSTRACT

A massager structure is provided, which includes a square plate. A top of a square plate is fixedly connected to a lower shell, and a bottom of the lower shell is fixedly connected to a motor. An output end of the motor is fixedly connected to a connection column, an outer wall of the connection column is fixedly connected to a second gear. A top of the connection column is fixedly connected to an arc-shaped massage rod, a top of the lower shell is fixedly connected to a plurality of hollow fixed rings at equidistant intervals, internals of the hollow fixed rings are connected to a fixed short rod, an outer wall of the fixed short rod is fixedly connected to a first gear, which meshes with the second gear. The arc-shaped massage rod is driven by the motor to rotate and massage a middle part of a massage area.

### CROSS-REFERENCE TO RELATED APPLICATIONS

This application claims priority to Chinese Patent Application No. 202422888277.4, filed on Nov. 26, 2024, which is hereby incorporated by reference in its entirety.

### TECHNICAL FIELD

The present disclosure relates to the field of massager technologies, and in particular, to a massager structure.

### BACKGROUND

A massager is a device specifically designed to physically stimulate muscles, joints, and soft tissues in the human body, in order to relieve muscle tension, reduce pain, promote blood circulation, and relax the mind and body. It simulates artificial massage techniques such as kneading, massage, shaking, squeezing, and friction, acting on specific parts of the body to help a user relieve fatigue and discomfort. For example, when people work or exercise for a long time, muscles become stiff and sore. The massager can use its internal mechanical device or electronic function to massage these fatigued muscles and relax them.

The existing massagers use mechanical massage methods, such as the common roller massager, which has a plurality of rollers inside. When the massager moves on a body part, the rollers roll along with the body contour, thereby achieving massage effects through compression and friction of muscles. However, after fitness exercises, it is impossible to massage the user's entire body parts in a more fitting manner, and the force of the massager cannot be unified, resulting in the user's body not being able to relax well. The existing technology uses the chain, belt, and transmission components inside the massager to accurately transmit the power of the motor to the massage head to achieve kneading, thereby ensuring that an output force of the massage head is stable and consistent. However, during a process of body massage, the massager cannot achieve good relaxation, only a surrounding of the massage area can be massaged, and a middle of the massage area cannot be massaged simultaneously, thereby reducing the user's experience when using the massager.

### SUMMARY

In order to overcome the above shortcomings, the present disclosure provides a massager structure aimed at improving problems in the prior art that massagers can only massage a surrounding area of a massage area and cannot simultaneously massage a middle part of the massage area during body massage.

In order to achieve the above objectives, the present disclosure adopts the following technical solution: a massager structure, including a square plate, where a top of the square plate is fixedly connected to a lower shell, a bottom of the lower shell is fixedly connected to a motor, an output end of the motor is fixedly connected to a connection column, an outer wall of the connection column is fixedly connected to a second gear, a top of the connection column is fixedly connected to an arc-shaped massage rod, and a top of the lower shell is fixedly connected to a plurality of hollow fixing rings at equidistant intervals; internals of the hollow fixing rings are rotatably connected to a fixed short rod, an outer wall of the fixed short rod is fixedly connected to a first gear, and the second gear is meshed with the first gear.

In some embodiments of the present disclosure: a top of the lower shell is fixedly connected to an upper shell, and a top of the upper shell is fixedly connected to a plurality of L-shaped fixing blocks at equidistant intervals; middles of the outer walls of the L-shaped fixing blocks are rotatably connected to a fixed short column, an outer wall of the fixed short column is fixedly connected to an arc-shaped clamping block.

In some embodiments of the present disclosure: an outer wall of the arc-shaped massage rod is fixedly connected to a rubber ring, and a top of the rubber ring is fixedly connected to a massage sleeve.

In some embodiments of the present disclosure: a protective shell is fixedly connected to a bottom of the lower shell.

In some embodiments of the present disclosure: a battery storage box is fixedly connected to a left of an outer wall of the protective shell.

In some embodiments of the present disclosure: hollow columns are fixedly connected to front and rear sides of an outer wall of the protective shell.

The present disclosure has the following beneficial effects.
1. In the present disclosure, the motor is turned on to drive the connection column fixedly connected to the output end to rotate. When the connection column rotates, it will also drive the arc-shaped massage rod at the top to rotate and massage a middle of an massage area, thereby avoiding a problem of the massager only being able to massage a surrounding of the massage area and not the middle of the massage area during the body massage process. This increases the user's experience when using the massager.
2. In the present disclosure, the second gear of the outer wall of the connection column meshes with the first gear of the outer wall of the fixed short rod, the first gear is driven to rotate. Because the top of the fixed short rod is fixedly connected to the bottom of the arc-shaped clamping block on the outer wall of the fixed short column, the arc-shaped clamping block will knead the massage area, ensuring that the force of the arc-shaped clamping block during massage is consistent, thereby achieving the effect of synchronous massage on the massage area.

### BRIEF DESCRIPTION OF DRAWINGS

FIG. 1 is a perspective structural view of a massager proposed by the present disclosure.

FIG. 2 is a side structural view of the massager proposed by the present disclosure.

FIG. 3 is a partially exploded structural view of the massager proposed by the present disclosure.

FIG. 4 is a partial structural disassembly diagram of the massager proposed by the present disclosure.

FIG. 5 is a partial schematic structural diagram of the massager proposed by the present disclosure.

Numeral reference: 1—square plate; 2—upper shell; 3—L-shaped fixing block; 4—arc-shaped massage rod; 5—rubber ring; 6—massage sleeve; 7—arc-shaped clamping block; 8—fixed short column; 9—battery storage box; 10—protective shell; 11—lower shell; 12—motor; 13—fixed short rod; 14—first gear; 15—second gear; 16—hollow fixing ring; 17—connection column; 18—hollow column.

### DESCRIPTION OF EMBODIMENTS

The following will provide a clear and complete description of the technical solution in the embodiments of the present disclosure, based on the accompanying drawings. Obviously, the described embodiments are only a part of the embodiments of the present disclosure, not all of them. Based on the embodiments in the present disclosure, all other embodiments obtained by those skilled in the art without creative work are within the protection scope of the present disclosure.

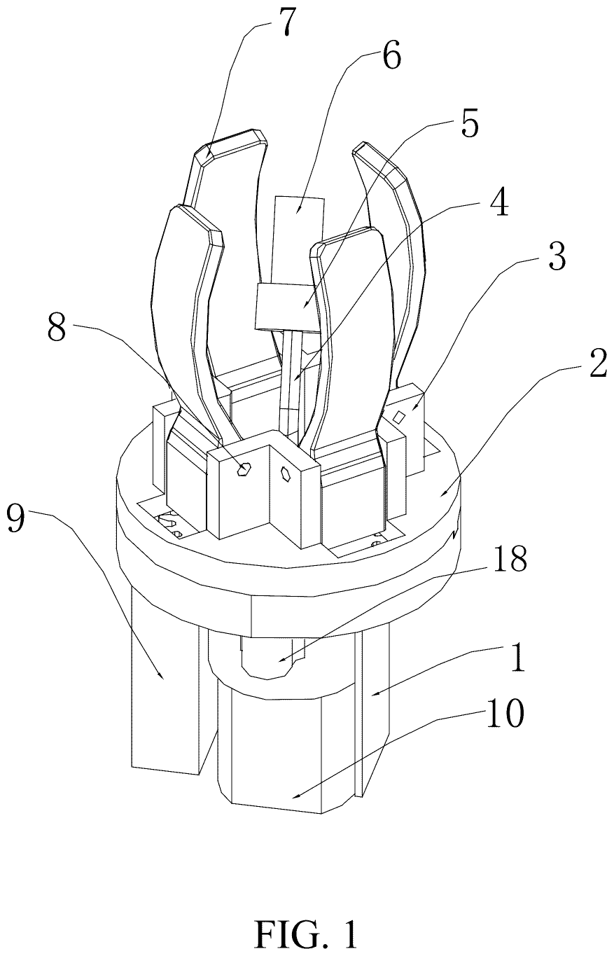

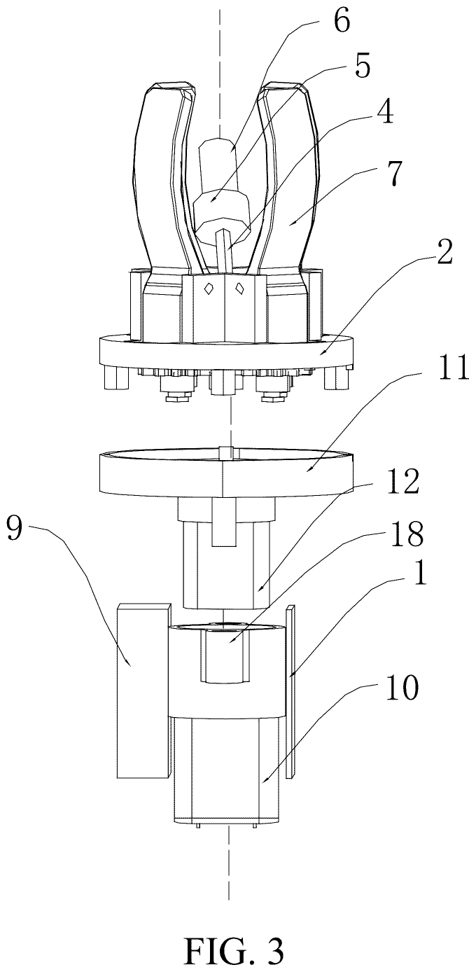

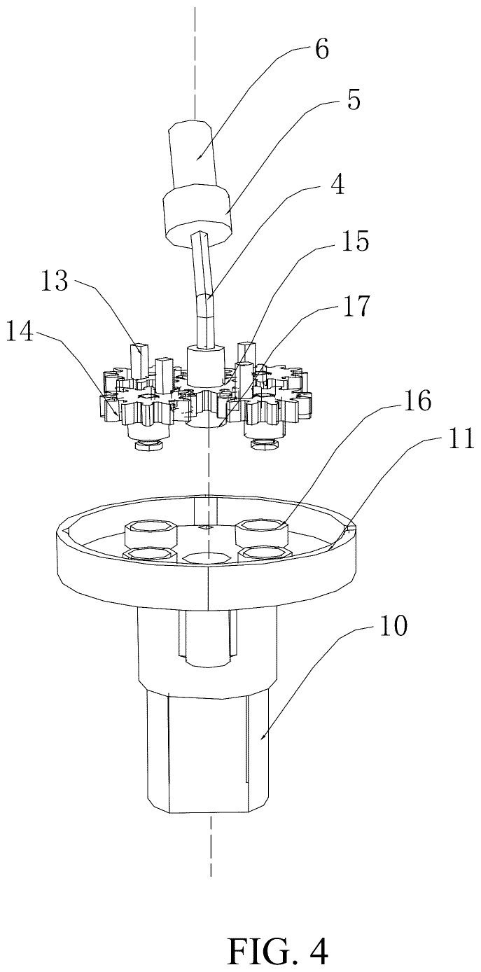

Referring to FIGS. 1, 3, and 4, an embodiment of the present disclosure provides a massager structure, including a square plate 1. A top of the square plate 1 is fixedly connected to a lower shell 11, and a bottom of the lower shell 11 is fixedly connected to a motor 12. The lower shell 11 plays a role in fixing the motor 12, and the motor 12 plays a driving role. An output end of the motor 12 is fixedly connected to a connection column 17, and the output end of the motor 12 is fixedly connected to the connection column 17 for rotation. An outer wall of the connection column 17 is fixedly connected to a second gear 15, and the second gear 15 on the outer wall of the connection column 17 plays a rotating role. A top wall of the connection column 17 is fixedly connected to an arc-shaped massage rod 4, and the connection column 17 rotates while rotating, thereby driving the arc-shaped massage rod 4 to rotate and massage. A top of the lower shell 11 is fixedly connected to a plurality of hollow fixing rings 16 at equidistant intervals, and internals of the hollow fixing rings 16 are connected to a fixed short rod 13. An outer wall of the fixed short rod 13 is fixedly connected to a first gear 14, and the fixed short rod 13 serves to fix the first gear 14. The second gear 15 meshes with the first gear 14 to rotate simultaneously. An outer wall of the arc-shaped massage rod 4 is fixedly connected to a rubber ring 5, and a top of the rubber ring 5 is fixedly connected to a massage sleeve 6. The massage sleeve 6 on the top of the rubber ring 5 can enhance the user's massage experience.

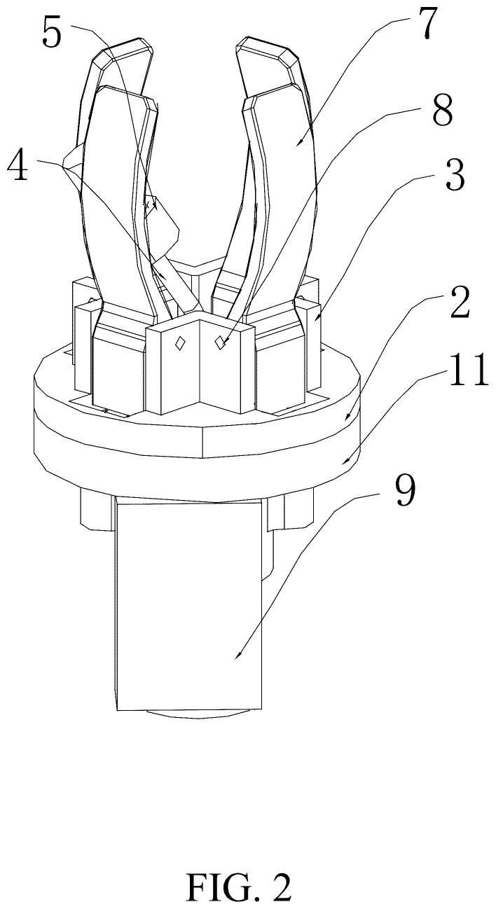

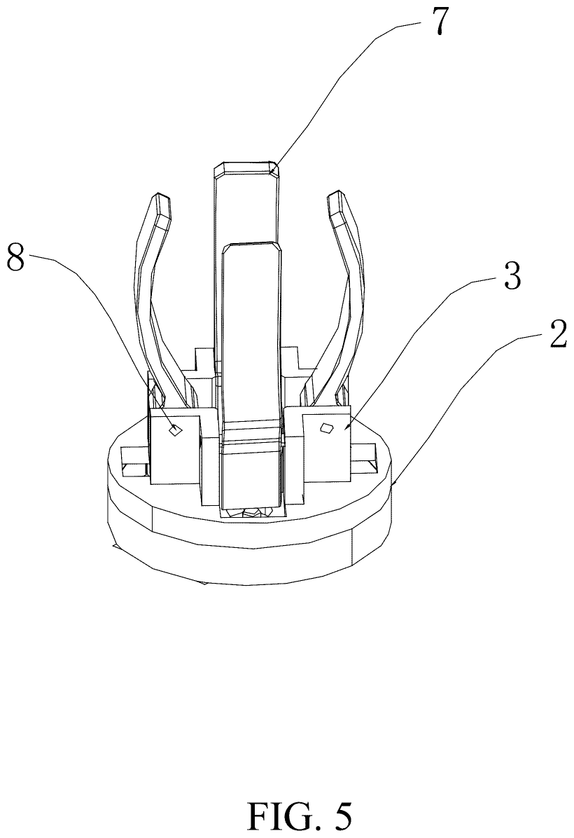

Referring to FIGS. 1, 2, and 5, the top of the lower shell 11 is fixedly connected to an upper shell 2, and a top of the upper shell 2 is fixedly connected to a plurality of L-shaped fixing blocks 3 at equidistant intervals. The upper shell 2 plays a role in fixing the L-shaped fixing blocks 3, and middles of outer walls of the L-shaped fixing blocks 3 are rotatably connected to a fixed short column 8. The fixed short column 8 plays a role in rotation, and an outer wall of the fixed short column 8 is fixedly connected to an arc-shaped clamping block 7. The arc-shaped clamping block 7 on the outer wall of the fixed short column 8 plays a role in kneading and massaging. A left of an outer wall of a protective shell 10 is fixedly connected to a battery storage box 9, and the battery storage box 9 can store spare batteries for future use.

Referring to FIG. 1, hollow columns 18 are fixedly connected to front and rear sides of an outer wall of the protective shell 10, the hollow columns 18 serve to reinforce the connection with the lower shell 11.

Working principle: by opening the lower shell 11 at the top of the square plate 1 and the motor 12 fixedly connected at the bottom, the connection column 17 fixedly connected to the output end of the motor 12 is driven to rotate. When the connection column 17 rotates, it will drive the second gear 15 on the outer wall to rotate and mesh with the first gear 14 on the outer wall of the fixed short rod 13. The arc-shaped massage rod 4 at the top of the connection column 17 will rotate and massage a middle part of a massage area, and the massage force can be controlled by adjusting a rotation speed of the motor 12, thereby avoiding a problem of the massager only massaging a surrounding area of the massage area and not simultaneously massaging the middle part of the massage area during the body massage process. This increases the user's user experience when using this massager.

By meshing the second gear 15 on the outer wall of the connection column 17 with the first gear 14 on the outer wall of the fixed short rod 13, the first gear 14 is driven to rotate. Because the top of the fixed short rod 13 is fixedly connected to the bottom of the arc-shaped clamping block 7 on the outer wall of the fixed short column 8, the arc-shaped clamping block 7 will knead the massage area, thereby ensuring that the force of the arc-shaped clamping block 7 during massage is consistent, thus achieving the effect of synchronous massage on the massage area.

Finally, it should be noted that the above description is only preferred embodiments of the present disclosure and is not intended to limit the present disclosure. Although the present disclosure has been described in detail with reference to the aforementioned embodiments, those skilled in the art may still modify the technical solutions described in the aforementioned embodiments or equivalently replace some of the technical features. Any modifications, equivalent replacements, improvements, etc. made within the spirit and principles of the present disclosure should be included in the protection scope of the present disclosure.

What is claimed is:

1. A massager structure, comprising a square plate, wherein a top of the square plate is fixedly connected to a lower shell, a bottom of the lower shell is fixedly connected to a motor, an output end of the motor is fixedly connected to a connection column, an outer wall of the connection column is fixedly connected to a second gear, a top of the connection column is fixedly connected to an arc-shaped massage rod, and a top of the lower shell is fixedly connected to a plurality of hollow fixing rings at equidistant intervals;
internals of the hollow fixing rings are rotatably connected to a fixed short rod, an outer wall of the fixed short rod is fixedly connected to a first gear, and the second gear is meshed with the first gear.

2. The massager structure according to claim 1, wherein a top of the lower shell is fixedly connected to an upper shell, and a top of the upper shell is fixedly connected to a plurality of L-shaped fixing blocks at equidistant intervals;
middles of the outer walls of the L-shaped fixing blocks are rotatably connected to a fixed short column, an outer wall of the fixed short column is fixedly connected to an arc-shaped clamping block.

3. The massager structure according to claim 1, wherein an outer wall of the arc-shaped massage rod is fixedly connected to a rubber ring, and a top of the rubber ring is fixedly connected to a massage sleeve.

4. The massager structure according to claim 1, wherein a protective shell is fixedly connected to a bottom of the lower shell.

5. The massager structure according to claim 4, wherein a battery storage box is fixedly connected to a left of an outer wall of the protective shell.

6. The massager structure according to claim 4, wherein hollow columns are fixedly connected to front and rear sides of an outer wall of the protective shell.
